(19) United States
(12) Patent Application Publication
(10) Pub. No.: US 2016/0285970 A1
(43) Pub. Date: Sep. 29, 2016

(54) NETWORK COMMUNICATION BETWEEN VIRTUAL MACHINE APPLICATIONS VIA DIRECT MEMORY ACCESS

(71) Applicant: International Business Machines Corporation, Armonk, NY (US)

(72) Inventors: JunJie Cai, Cary, NC (US); San Hong Li, Shaghai (CN); Chuan Sheng Lu, Shanghai (CN)

(21) Appl. No.: 14/670,562

(22) Filed: Mar. 27, 2015

(51) Int. Cl. H04L 29/08; G06F 9/455; G06F 3/06; H04L 29/06

(52) U.S. Cl. CPC H04L 67/1097; H04L 69/16; G06F 9/45558; G06F 3/061; G06F 3/0631; G06F 3/067; G06F 2009/45583

(57) ABSTRACT

A method for transferring data utilizing direct memory access. The method includes a computer processor identifying a first computing entity and a second computing entity that are transferring data. The method further includes establishing one or more transmission control protocol networking connections between the first computing entity and the second computing entity. The method further includes determining a shared memory space for the first computing entity and the second computing entity to utilize for transferring the data, wherein the shared memory space includes unused memory space. The method further includes allocating memory space of the determined shared memory space to the first computing entity and the second computing entity and communicating a memory address that corresponds to the allocated memory space. The method further includes transferring the data between the first computing entity and the second computing entity utilizing direct memory access and the allocated memory space.

### BACKGROUND OF THE INVENTION

The present invention relates generally to the field of data transfer within virtualized computing environments, and more particularly to data transfer within a computing node by directly utilizing shared system memory.

In system virtualization, multiple virtual machines (VMs) are created within a single physical computing system. The physical system can be a stand-alone computer, or alternatively, a computing system utilizing clustered computers and components. Virtual systems are independent operating environments that use virtual resources made up of logical divisions of physical resources, such as processors, memory, and input/output (I/O) adapters. A hypervisor provides the ability to divide physical computing system resources into isolated logical partitions. Each logical partition operates like an independent computing system running its own operating system (e.g., a virtual system). The independent operating environments controlled by a hypervisor may be structured in various schemes and hierarchies. For example, each logical partition within a virtualized environment may have a different operating system with multiple VMs utilizing that operating system where the VM is a computing entity for a user. Some virtualized systems permit a VM to support multitenancy of a runtime system (runtime) or a shared container in a cloud computing application. In some virtualized systems, each tenant may be treated as a computing entity.

In addition to creating and managing the logical partitions, the hypervisor manages communication between the logical partitions via a virtual switch. To facilitate communication, each logical partition may have a virtual adaptor for communication between the logical partitions via the virtual switch. The type of the virtual adapter depends on the operating system used by the logical partition. Examples of virtual adapters include virtual Ethernet adapters, virtual fiber channel adapters, virtual small computer serial interface (SCSI) adapters, and virtual serial adapters.

In system virtualization, each computing entity behaves as if it were a separate computer; information and data are transferred (e.g., communicated) utilizing computer networking. In computer networking, the transport layer provides end-to-end communication services for applications within a layered architecture of network components and protocols. The transport layer provides convenient services (e.g., application programming interfaces), such as connection-oriented data stream support, reliability, flow control, socket creation, socket closing, data transmission, and multiplexing. Examples of transport protocols include the transmission control protocol (TCP), user datagram protocol (UDP), and the Virtual Machine Communication Interface (VMCI) protocol. Communication between applications within the same virtualized system progresses through a networking software stack associated with a first application and another networking software stack for the second application. Alternatively, a modification of an infrastructure, such as VMCI, provides fast (e.g., low latency) and efficient (e.g., high bandwidth) communication between a virtual machine and the host operating system and between two or more virtual machines on the same host (i.e., the same physical real computer).

### SUMMARY

Aspects of an embodiment of the present invention disclose a method, computer program product, and computing system for transferring data utilizing direct memory access. The method includes a computer processor identifying, by one or more computer processors, a first computing entity and a second computing entity that are transferring data. The method further includes a computer processor establishing one or more transmission control protocol (TCP) networking connections between the first computing entity and the second computing entity. The method further includes a computer processor determining a shared memory space for the first computing entity and the second computing entity to utilize for transferring the data, wherein the shared memory space includes unused memory space. The method further includes a computer processor allocating memory space of the determined shared memory space to the first computing entity and the second computing entity. The method further includes a computer processor communicating a memory address that corresponds to the allocated memory space to the first computing entity and the second computing entity. The method further includes a computer processor and transferring the data between the first computing entity and the second computing entity utilizing direct memory access and the allocated memory space.

### BRIEF DESCRIPTION OF THE DRAWINGS

FIG. 1 illustrates a virtualized computing environment, in accordance with an embodiment of the present invention.

FIG. 2 depicts a flowchart of steps of a fast path communication program, in accordance with an embodiment of the present invention.

FIG. 3 depicts a flowchart of steps of a shared memory allocation program, in accordance with an embodiment of the present invention.

FIG. 4 depicts a flowchart of steps of a fast path memory management program, in accordance with an embodiment of the present invention.

FIG. 5a illustrates a multitenant fast path communication architecture within a shared virtual machine (VM) executing on a computing node within a virtualized computer environment, in accordance with an embodiment of the present invention.

FIG. 5b illustrates multiple VMs utilizing a fast path communication architecture within a shared operating system (OS) executing on a computing node within a virtualized computer environment, in accordance with an embodiment of the present invention.

FIG. 6 depicts a block diagram of components of a computer, in accordance with an embodiment of the present invention.

### DETAILED DESCRIPTION

Embodiments of the present invention recognize that transferring data and information within a computing node of a virtualized computing environment may be slowed due to various implementations of network communication. For example, a first application invokes a network application programming interface (API), which subsequently invokes a native interface (NI) specific to the programming language of the application. The NI may be handled by a native API that interacts with the operating system kernel, which in turn accesses the transmission control protocol (TCP) stack. A similar series of events occurs for a second application that is transferring data with the first application since the data transfer is treated as network communication. Multi-layered overhead (e.g., increased latency, consumes additional system resources) may be involved when the data transfer is between tenants within the same VM between applications on different VMs executing within the same operating system and between applications executing within different operating systems within the same hypervisor.

Embodiments of the present invention recognize that various operating systems provide shortcuts for the networking sockets within one OS. One such shortcut permits the data/information (e.g., object) that is exchanged to be copied from user-mode to kernel mode. Embodiments of the present invention are implemented at the level of the user-mode to provide a fast path communication solution. Embodiments of the present invention also recognize that applications written utilizing various software languages and software development kits (SDKs) are unaffected (e.g., can execute without modifications) when implementing a fast path communication solution. Some embodiments modify the implementation codes for calling an OS's transportation layer networking (e.g., socket creation, port identification, etc.) and when available to redirect communication through a fast path communication solution. Other embodiments may affect the creation on monitoring of sockets via the network connection management code of the SDK. Such embodiments dictate modifying the source code of an application or recompiling of an application to utilize the fast path communication solution.

Embodiments of the present invention determine whether the applications (e.g., computing entities) that communicate data/information (e.g., object) execute within the same physical computing node, and if so, transfer the data (e.g., object) via direct memory access (e.g., reducing latency). However, the dynamic nature of memory management within a virtualized computing environment may move data or reclaim/reallocate memory space. Additional embodiments incorporate additional controls to protect the address locations and memory space allocated for the transfer of data until an application has consumed the data (e.g., an object) and flagged the data as “dead” (e.g., unneeded). For example, an object may be designated as “dead” when: the object is not utilized by an executing application, the object is not referenced by a executing application, and the object “finalized” by a method function within an executing application.

Embodiments of the present invention recognize that some networking functions and protocols available within the virtualized computing environment can be adapted to implement the present invention. For example, various embodiments utilize TCP and the socket registry. Other embodiments create, utilize, and update tables herein identified as global socket registry tables that identify the endpoints (e.g., host name, identity information, process number, port number, etc.) of a communication path of the computing entities. Additional embodiments also recognize that some software languages, SDKs, and runtimes include specialized networking functions, network classes, encapsulate the transportation layer networking, and high-level application protocols (e.g., simple mail transfer protocol (SMTP)). Some embodiments of the present invention may utilize capabilities to an OS or a hypervisor.

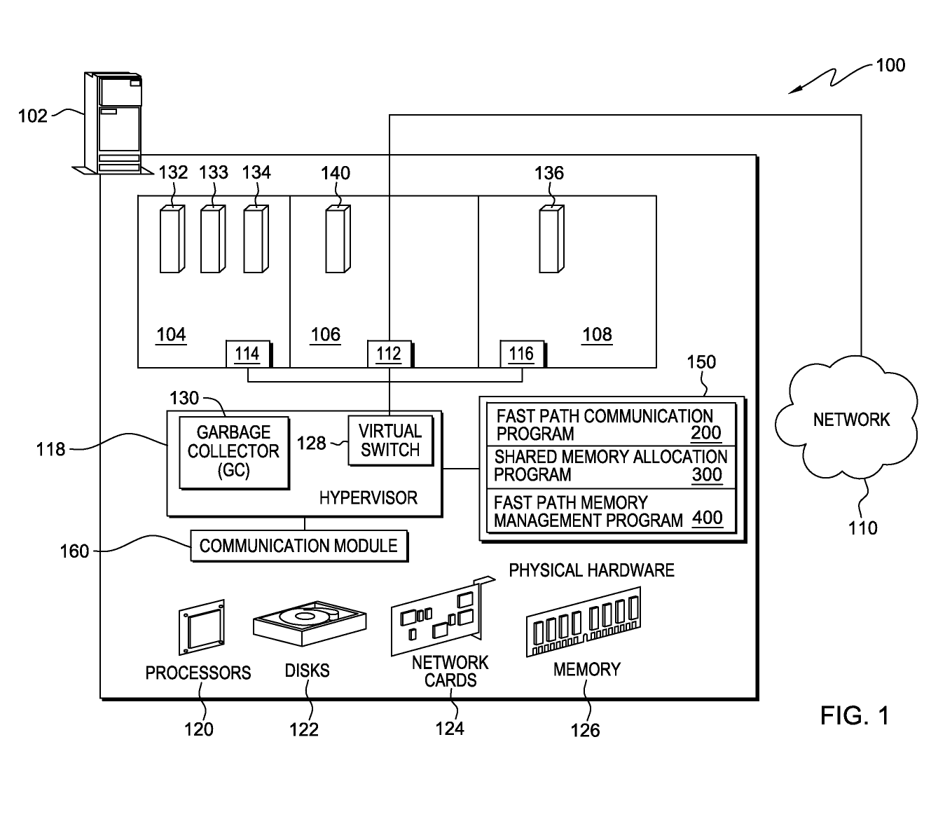

The present invention will now be described in detail with reference to the Figures. FIG. 1 illustrates virtualized computing environment 100, which includes computing node 102. Computing node 102 is divided into multiple logical partitions that include logical partitions 104, 106, and 108. In the illustrated example for computing node 102, logical partitions 104, 106, and 108 each run an independent operating environment, such as an operating system (OS). In some embodiments, logical partition 104 contains VM 132, VM 133, and VM 134 executing a shared OS, which in this instance may be AIX®. Logical partition 106 contains VM 140 executing another OS, which in this instance is virtual I/O server (VIOS). Logical partition 108 contains VM 136 executing yet another OS, which in this instance is Linux®. In other embodiments, logical partitions 104, 106, and 108 may include a different number of provisioned VMs. In further embodiments, logical partitions 104, 106, and 108 can include other operating environments and combinations of operating environments. In various embodiments of the present invention, any number of partitions may be created and may exist on separate physical computers of a clustered computer system.

Communications from network 110 are routed through shared Ethernet adapter (SEA) 112 on logical partition 106 to virtual adapters 114 and 116 on respective logical partitions 104 and 108, in accordance with an embodiment of the present invention. Communications from virtual adapters 114 and 116 on respective logical partitions 104 and 108 may be routed through SEA 112 on logical partition 106 to network 110. In an alternative embodiment, physical network adapters are allocated to logical partitions 104, 106, and 108.

Hypervisor 118 forms logical partitions 104, 106, and 108 from the physical resources of computing node 102. The physical hardware of computing node 102 is comprised of: processors 120, disks 122, network cards 124, and/or memory 126, which is shared among local partitions 104, 106, and 108. Hypervisor 118 performs standard operating system functions and manages communication between logical partitions 104, 106, and 108 via virtual switch 128. Virtual switch 128 is a software program that allows one virtual machine to communicate with another. Virtual switch 128 may be configured to create a virtual local area network (VLAN) within computing node 102. In some embodiments, computing node 102 may utilize other technologies, such as VMCI or virtual network interface cards (VNIC), to enhance the communications with virtual adapters 114 and 116 or to replace virtual adapters 114 and 116. Virtual switch 128 may be embedded into virtualization software or may be included in a server's hardware as part of its firmware. Hypervisor 118 may assign a unique identifier, such as a process identified (PID), to each computing entity within computing node 102.

In some embodiments, computing node 102 communicates through network 110 to other computing nodes (not shown) within virtualized computing environment 100, other virtualized computing environments (not shown), and other computers (not shown). Network 110 can be, for example, a local area network (LAN), a telecommunications network, a wireless local area network (WLAN), a wide area network (WAN), such as the Internet, or any combination of the previous, and can include wired, wireless, or fiber optic connections. In general, network 110 can be any combination of connections and protocols that will support communications between processors 120 and computing node 102, in accordance with embodiments of the present invention. In another embodiment, network 110 operates locally via wired, wireless, or optical connections and can be any combination of connections and protocols (e.g., NFC, laser, infrared, etc.). In some embodiments, a physical computer, such as computing node 102 is identified by a media access control address (MAC address), which is a unique identifier assigned to network interfaces for communications on the physical network segment.

Garbage collector (GC) 130 is an automatic memory management function. Garbage, in the context of computer science, refers to objects, data, or other regions of the memory of a computer system (or other system resources), which are not be used (e.g., are classified as “dead”) in any future computation by the system or by a program running on the system. As computer systems all have finite amounts of memory, it is frequently necessary to deallocate garbage and return the deallocated garbage to the heap or memory pool so the underlying memory can be reused. In some embodiments of the present invention, a modified version of GC 130 is included in fast path direct memory access module 150. In some scenarios, the modified version of GC 130 functions in conjunction with GC 130. In other scenarios, the modified version of GC 130 preempts the activity of GC 130 when an embodiment of the present invention utilizes a fast path communication solution.

Fast path direct memory access module 150 includes fast path communication program 200, shared memory allocation program 300, and fast path memory management program 400. Fast path direct memory access module 150 may include shareable memory functions (not shown) and communication functions (not shown) that respond to embodiments of the present invention to generate the interaction that produce the fast path communication solution (e.g., a path). For example, communication controls, such as send/receive locks ensure correct read/write sequencing of shared heap memory space, which is shared by different threads. In some embodiments, fast path direct memory access module 150 includes one or more global socket registry tables, such as: a fastPathForSharedRunTimeSharedVM table, a fastPathForSharedOS table, and a fastPathForSharedHypervisor table.

Fast path communication program 200 determines whether computing entities (e.g., applications, tenants, virtual machines) executing within computing node 102 can communicate and exchange data at an application level (e.g. user-mode) via direct memory access. Fast path communication program 200 interfaces with shared memory allocation program 300 to determine a level at which the communication occurs and one or more memory addresses are utilized for the transfer of an object (e.g., data).

Shared memory allocation program 300 receives an object that is subsequently transferred from one entity to another entity. Shared memory allocation program 300 interfaces with fast path communication program 200 to determine a level at which the communication occurs via the TCP connection endpoints registered within one of the global socket registry tables. In addition, shared memory allocation program 300 allocates memory from the shared heap and determines the one or more memory addresses utilized for transferring the object. In one embodiment, shared heap memory is a portion of memory 126 that hypervisor 118 provisioned for VM 136. In another embodiment, shared heap memory is a portion of memory 126 that hypervisor 118 provisioned for logical partition 104 that is shared by VM 132, VM 133, VM 134, and the OS of logical partition 104.

Fast path memory management program 400 modifies a header of an object/buffer and updates the managed memory list of GC 130. Fast path memory management program 400 prevents GC 130 from moving or deallocating the memory containing the object/buffer until fast path memory management program 400 determines that the object/buffer is designated as “dead.” When fast path memory management program 400 determines that an object/buffer is “dead,” fast path memory management program 400 updates the managed memory list of GC 130 permitting GC 130 to reclaim shared memory.

Communication module 160 is connected to hypervisor 118 and includes look-up tables to track various communication protocols, port numbers, and socket addresses utilized to communicate between various computing entities. In other embodiments, communication module 160 includes look-up tables (e.g., global socket registry tables) identifying the real TCP connections utilized by the communication solution between the computing entities. For example, three such tables that are associated with a fast path communication solution are identified herein as: fastPathForSharedRunTimeSharedVM, fastPathForSharedOS, and fastPathForSharedHypervisor. In addition, communication module 160 may interact with a memory management function (not shown) that allocates memory from the heap to the sending and receiving buffers.

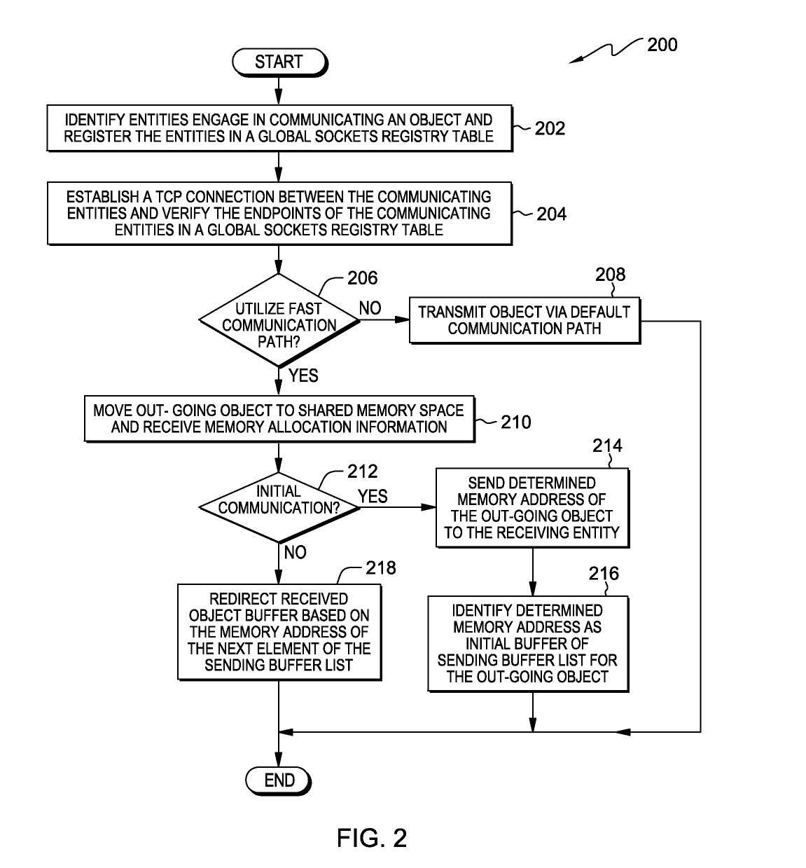

FIG. 2 is a flowchart depicting operational steps for fast path communication program 200 executing within computing node 102 within virtualized computing environment 100 of FIG. 1. Fast path communication program 200 determines whether computing entities (e.g., applications, tenants, virtual machines) executing within computing node 102 can engage in application level (e.g., user-mode) data exchange, as opposed to kernel communication or utilizing the networking software stack. In one embodiment, fast path communication program 200 determines whether computing entities executing within computing node 102 can engage in application level data exchange by analyzing which OSs and SDKs are associated with the computing entities and whether the OS s and SDKs include APIs and utilities needed to enable a fast path communication solution. In addition, fast path communication program 200 interfaces with shared memory allocation program 300 to identify one or more memory addresses utilized to transfer the object between computing entities.

In step 202, fast path communication program 200 identifies entities engaged in communicating an object and registers the entities in a global socket registry table. In an embodiment, fast path communication program 200 utilizes communication module 160 to “listen” (e.g., monitor) to various ports to determine which ports are activated by a computing entity (i.e., entity) initiating a communication and registers an endpoint (e.g., IP address, port number, etc.) for each communication within the global socket registry tables. In some embodiments, fast path communication program 200 monitors: programs, applications, websites, VMs, databases, etc., which comprise the computing entities (e.g., entities) hosted on computing node 102 that transfer information and data. In addition, fast path communication program 200 identifies the object (e.g., file, data, information, database, etc.) that is transferred between the computing entities. For example, fast path communication program 200 determines that VM 136 engages in communicating a file (not shown) to VM 132 via a VLAN established by virtual switch 128, comprised of virtual adapters 112, 114, and 116. Subsequently, fast path communication program 200 determines the respective endpoints of VM 136 and VM 132.

In step 204, fast path communication program 200 establishes a TCP connection between the communicating entities and verifies the endpoints of the communicating entities in a global socket registry table. Fast path communication program 200 establishes a TCP connection between the communicating computing entities to establish a logical connection and updates the endpoints in the global socket registry tables based on the connection. For example, fast path communication program 200 may utilize communication module 160 to establish the TCP connection between VM 136, via virtual adapter 116, and VM 132, via virtual adapter 114. Subsequently, fast path communication program 200 determines the endpoints (e.g., port numbers, socket addresses, NIC addresses, MAC addresses, etc.) of the communicating computing entities and updates the registered endpoints in one or more global socket registry tables stored in communication module 160. Subsequently, shared memory allocation program 300 utilizes the endpoints of the communicating computing entities, registered by fast path communication program 200, to determine which fast path communication solution is executed.

In decision step 206, fast path communication program 200 determines whether the communicating computing entities utilize a fast communication path. In one embodiment, fast path communication program 200 determines that the communicating computer entities are both registered within a global socket registry table assigned to a fast path communication solution; and therefore, the communicating computer entities utilize a fast communication path. In another embodiment, fast path communication program 200 determines that the communicating computing entities (e.g., the first entity, the second entity) are not registered in the same global socket registry table or a global socket registry table assigned to a fast path communication solution; and therefore, do not utilize a fast communication path. In one scenario, fast path communication program 200 determines that the communicating computing entities execute on different computing nodes within virtualized computing environment 100. For example, fast path communication program 200 communicates with hypervisor 118 and determines that one computing entity was not provisioned by hypervisor 118. In one instance, previsioned VM does not have a PID assigned by hypervisor 118. In another scenario, fast path communication program 200 determines that at least one entity executes on a different (e.g., hardware) virtualized computing environment (not shown). For example, fast path communication program 200 communicates with hypervisor 118 and determines that one computing entity communicates via SEA 112 as opposed to a VLAN created by virtual switch 128.

In decision step 206, in response to a determination that the communicating computing entities do not utilize a fast communication path (no branch, decision step 206), fast path communication program 200 transmits the object via a default communication path (step 208).

In step 208, fast path communication program 200 transmits the object via a default communication path. In one embodiment, fast path communication program 200 utilizes the TCP connection established in step 204 to transmit the object between the computing entities. In another embodiment, fast path communication program 200 utilizes a different communication protocol (e.g., hypertext transfer protocol (HTTP), file transfer protocol (FTP), user datagram protocol (UDP), etc.) to transmit the object between the computing entities. In some embodiments, fast path communication program 200 defaults to a high-speed communication technology (e.g., VLAN, etc.) employed by computing node 102 to transmit the object between the computing entities. In other embodiments, fast path communication program 200 transfers control for transmitting the object to communication module 160 and SEA 112 to communicate, via network 110, with a computing entity that executes outside of virtualized computing environment 100.

Referring to decision step 206, in response to a determination that the communicating computing entities utilize a fast communication path (yes branch, decision step 206), then fast path communication program 200 moves the out-going object to shared memory space and receives memory allocation information (step 210).

In step 210, fast path communication program 200 moves an out-going object to shared memory (e.g., heap) space and receives memory allocation information (e.g., from shared memory allocation program 300). Fast path communication program 200 initiates a first send operation and copies the out-going object into the shared heap memory. In one embodiment, fast path communication program 200 receives memory allocation information that indicates that the out-going object is contained within a contiguous block of shared memory space and the determined memory address for the start of the contiguous block of shared memory. In one scenario, fast path communication program 200 receives additional information indicating the size of the contiguous memory block allocated to the out-going object. In another scenario, fast path communication program 200 receives additional information indicating second memory address that forms the range of the contiguous memory block allocated to the out-going object. In another embodiment, fast path communication program 200 receives information indicating that the out-going object is allocated to two or more non-contiguous (e.g., fragmented) blocks of shared memory. In this embodiment, fast path communication program 200 receives memory address information for each of the two or more non-contiguous blocks of shared memory comprising the object. In some embodiments, fast path communication program 200 receives multiple memory addresses and multiple memory pointers associated with the multiple sending buffers utilized by shared memory allocation program 300. In other embodiments, fast path communication program 200 receives the memory allocation and memory addresses associated with a queue comprised of one or more buffers.

In decision step 212, fast path communication program 200 determines whether the fast path transfer of an out-going object is the initial communication associated with the out-going object. In one embodiment, fast path communication program 200 determines that the transfer of an out-going object (e.g., data) is the initial communication by: detecting the first instance of a data chunk within an OS's real socket channel, the formation of the first buffer of a queue, a node in a linked list that both a “handle” and information the “next” (e.g., next link, next pointer) field. In another embodiment, fast path communication program 200 determines that the fast path transfer of an out-going object is not the initial communication associated with the out-going object. In one scenario, fast path communication program 200 determines that at least one dequeue command is issued to remove a buffer from the sending buffer list. In another scenario, fast path communication program 200 detects that an element of a linked list contains both a previous node field and a next-node link field. In a different scenario, fast path communication program 200 determines that an element of a linked list comprising the out-going is the last link (e.g., buffer) because it does not contain next-node link fields.

In decision step 212, in response to a determination that the fast path data transfer of on out-going object is the initial communication (e.g., send data, transmit data, etc.) (yes branch, decision step 212), fast path communication program 200 sends the determined memory address of the out-going object to the receiving entity (step 214).

In step 214, fast path communication program 200 sends the determined memory address of the out-going object to the receiving entity. In one embodiment, fast path communication program 200 communicates a pointer/memory offset referring to a location within the allocated memory associated with the out-going object. In another embodiment, fast path communication program 200 communicates the address of a first data chunk via an OS's real socket channel.

In step 216, fast path communication program 200 identifies the determined memory address as the initial buffer of the sending buffer list for the out-going object. In some embodiments, fast path communication program 200 utilizes the OS of the logical partition hosting the communicating computing entities to identify the “head” of the first buffer of the queue containing the out-going object as the initial buffer. For example, fast path communication program 200 utilizes the OS of the logical partition 104 to identify the initial buffer for an out-going object communicated from VM 132 to VM 134. In other embodiments, fast path communication program 200 utilizes the functions (e.g., commands) included in communication module 160 or hypervisor 118 to identify the “head” of the first buffer of the queue containing the out-going object as the initial buffer for computing entities executing on different OSs. For example, fast path communication program 200 utilizes commands within communication module 160 to identify the initial buffer for an out-going object communicated from VM 132, executing on logical partition 104, to VM 136, executing on logical partition 108.

Referring to decision step 212, in response to a determination that the fast path transfer of an out-going object is not the initial communication associated with the out-going object (no branch, decision step 212), fast path communication program 200 redirects the received object buffer based on the memory address of the next element of the sending buffer list (step 218).

In step 218, fast path communication program 200 redirects the received object buffer based on the memory address (e.g., index value) of the next element of the sending buffer list. After fast path communication program 200 executes the initial send operation, subsequent portions of the out-going object are directed to sending buffers within the shared heap space. In some embodiments, fast path communication program 200 utilizes the OS of the logical partition hosting the communicating computing entities to redirect and link elements of the sending buffer list (e.g., manage queue) containing the out-going object for computing entities executing within the same OS. In other embodiments, fast path communication program 200 utilizes the functions (e.g., commands) included in communication module 160 or hypervisor 118 to redirect and link elements of the sending buffer list (e.g., manage queue) containing the out-going object for computing entities executing on different OSs.

In one example, fast path communication program 200 links the redirected buffer (e.g., node) to the allocated shared memory space. Fast path communication program 200 identifies (e.g., by reference information, by “handle” information) the first buffer as the “head” of the linked list (e.g., queue) of sending buffers. Fast path communication program 200 identifies a next-node link and pointer (e.g., references a location in the allocated shared memory space) for first buffer. Fast path communication program 200 similarly links each node (e.g., a sending buffer) of the linked list that comprises the out-going object via respectively associated index values, next-node links, and pointers. In some scenarios, fast path communication program 200 responds to the buffer list as a data structure (e.g., a linked list) on shared heap space. In some instances, fast path communication program 200 utilizes the OS of the logical partition hosting the communicating computing entities to manage (add/get/remove) a group of buffers between a sender entity and a receiving entity. The sending entity “pushes” buffer pointers to the tail of the list, and receiving entity “peeks” the buffer pointer from the head of the list. In other instances, fast path communication program 200 utilizes the functions (e.g., commands) included in communication module 160 or hypervisor 118 to manage (add/get/remove) a group of buffers between a sender entity and a receiving entity (e.g., to manage the queue).

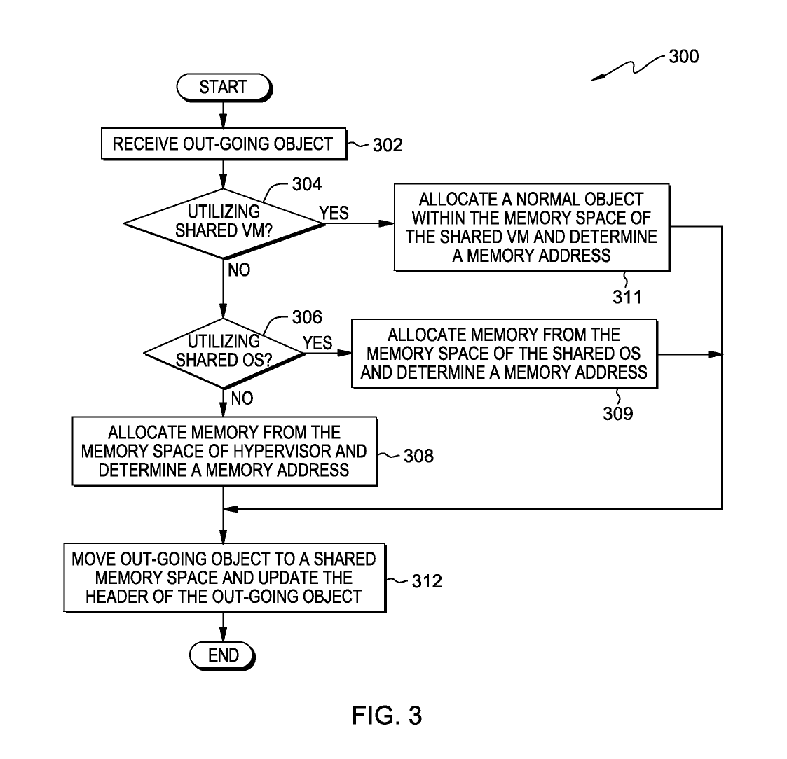

FIG. 3 is a flowchart depicting operational steps for shared memory allocation program 300, executing on computing node 102 within virtualized computing environment 100 of FIG. 1. Shared memory allocation program 300 determines which fast path communication solution of the present invention to utilize based on identifying the endpoints of the communicating computing entities utilizing TCP socket information stored in the global socket registry tables. Shared memory allocation program 300 interacts with fast path communication program 200. In addition, shared memory allocation program 300 allocates memory for implementing the present invention from shared physical memory, shared virtualized memory, and shared heap space.

In step 302, shared memory allocation program 300 receives an out-going object. In an example embodiment, shared memory allocation program 300 receives an out-going object that is the subject communication/data transfer between the computing entities (e.g., a first computing entity, a second computing entity). For example, shared memory allocation program 300 receives an out-going object from VM 132, executing on logical partition 104 to communicate with VM 136, executing on logical partition 108.

In decision step 304, shared memory allocation program 300 determines whether the communicating computing entities execute within the shared VM or runtime system. In one embodiment, shared memory allocation program 300 determines whether the communicating computing entities utilize a shared VM. In another embodiment, shared memory allocation program 300 determines whether the communicating computing entities utilize a shared VM. For example, shared memory allocation program 300 determines that both communicating computing entities are identified within global socket registry table fastPathForSharedRunTimeSharedVM stored in communication module 160. In yet another embodiment, shared memory allocation program 300 does not identify both communicating computing entities within global socket registry table fastPathForSharedRunTimeSharedVM stored in communication module 160.

In decision step 304, in response to a determination that that the communicating computing entities do not execute within the shared VM or runtime system (no branch, decision step 304), shared memory allocation program 300 checks whether the communicating computing entities execute utilizing a shared OS (decision step 306).

In decision step 306, shared memory allocation program 300 determines whether the communicating computing entities utilize a shared OS. In one embodiment, shared memory allocation program 300 determines that both communicating computing entities are identified within global socket registry table fastPathForSharedOS stored in communication module 160. In another embodiment, shared memory allocation program 300 communicates with hypervisor 118 to determine whether the PIDs assigned to the communicating computing entities are associated with the same logical partition. For example, VM 132 and VM 134 execute within the same logical partition 104 that utilizes a shared OS, which in this instance may be AIX®.

In a different embodiment, shared memory allocation program 300 verifies that the communicating computing entities execute within a computing node controlled by the hypervisor that provisioned the communicating computing entities. For example, hypervisor 118 of computing node 102 provisioned VMs 132, 133, 134, 136, and 140. Subsequently, shared memory allocation program 300 determines that both communicating computing entities are identified within global socket registry table fastPathForSharedHypervisor stored in communication module 160. Communicating computing entities not executing within the same hypervisor or not both registered within fastPathForSharedHypervisor are handled in FIG. 2 at step 206, and the object is transmitted via a default communication path.

In decision step 306, in response to a determination that the communicating computing entities execute within a shared hypervisor and do not execute within a shared OS (no branch, decision step 306), shared memory allocation program 300 allocates shared memory space of hypervisor 118 hosting the computing entities (step 308).

In step 308, shared memory allocation program 300 allocates memory from the shared memory space of hypervisor 118 and determines the memory address of the allocated memory space. In some embodiments, shared memory allocation program 300 communicates with hypervisor 118 to allocate memory space from memory 126 of computing node 102. In other embodiments, shared memory allocation program 300 communicates with hypervisor 118 to allocate memory space and utilizes memory controlled by hypervisor 118. Subsequently, shared memory allocation program 300 determines a memory address for the allocated memory space. In one embodiment, shared memory allocation program 300 allocates contiguous memory for an out-going object. In one scenario, shared memory allocation program 300 determines a pair of memory addresses that define the allocated memory space. In another scenario, shared memory allocation program 300 determines a memory address and the size of the block of memory that defines the shared memory space.

In another embodiment, shared memory allocation program 300 communicates with hypervisor 118 to determine that the allocated memory space is non-contiguous and that the out-going object is divided into multiple segments to utilize the non-contiguous memory space. In some instances, shared memory allocation program 300 determines a pair of memory addresses that defines the allocated memory space for a segment. In other instances, shared memory allocation program 300 determines a memory address and the size of the block of memory that define the allocated memory space of a segment. In some scenarios, the segments are distributed in memory blocks of equal size. In other scenarios, the segments are distributed in memory blocks of varying sizes. In some embodiments, shared memory allocation program 300 assigns a pointer to each memory block to facilitate associating the segments of allocated memory to buffer lists (e.g., sending buffer, receiving buffer). In various embodiments, the size of the communication buffers may affect which memory management functions and/or communication functions that shared memory allocation program 300 utilizes to communicate the out-going object.

Referring to decision step 306, in response to a determination that that the communicating computing entities execute within the shared OS (yes branch, decision step 306), shared memory allocation program 300 allocates memory space for the out-going object from the memory space of shared OS (step 309).

In step 309, shared memory allocation program 300 allocates memory from the memory space of the shared OS for the out-going object, and shared memory allocation program 300 determines a memory address of the allocated memory space. In one embodiment, shared memory allocation program 300 allocates memory from a logical partition hosting the communicating computing entities executing within the same OS. For example, shared memory allocation program 300 utilizes memory from logical partition 104 to create heap space allocated for communicating of an out-going object from VM 132 to VM 134. In some instances, shared memory allocation program 300 utilizes memory management functions of the shared OS to allocate the shared memory and to identify an address for the shared memory. In another embodiment, shared memory allocation program 300 communicates with hypervisor 118 to identify unused memory space within a logical partition to allocate for the communication of the out-going object. In a different embodiment, shared memory allocation program 300 communicates with hypervisor 118 to provision additional memory to a logical partition. Shared memory allocation program 300 subsequently utilizes the provisioned additional memory to allocate the shared memory space to the communication of the out-going object.

Referring to decision step 304, in response to a determination that the communicating computing entities utilize a shared VM (yes branch, decision step 304), shared memory allocation program 300 allocates a normal object and memory space within the shared memory space of the share VM (step 311).

In step 311, shared memory allocation program 300 allocates a normal object within the shared memory space of the shared VM, and shared memory allocation program 300 determines a memory address for the normal object. Shared memory allocation program 300 utilizes a normal object to facilitate the communication of the out-going object. In an embodiment, a normal object is a memory chunk that represents a programming language level object. In response to shared memory allocation program 300 determining that a fast path communication solution occurs within a shared VM (and the same OS), the memory of the shared VM is utilized by the applications executing within the VM. In this case, a memory copy operation (e.g., send and receive) is not utilized. In an embodiment, shared memory allocation program 300 allocates unused (e.g., free) memory form the heap. In another embodiment, shared memory allocation program 300 communicates with hypervisor 118 to provision additional memory for a VM. The provisioned additional memory is assigned to the heap, which shared memory allocation program 300 subsequently allocates a portion of to communicate the out-going object. In one example, shared memory allocation program 300 communicates with hypervisor 118 to provision memory from logical partition 108 to VM 136. In another example, shared memory allocation program 300 communicates with hypervisor 118 to provision addition memory from memory 126 to VM 136.

In a different embodiment, shared memory allocation program 300 dynamically allocates used memory within the heap when unused shared memory is not available. Shared memory allocation program 300 reallocates “free” (e.g., unused) memory to the normal object as the memory becomes available.

In step 312, shared memory allocation program 300 moves the out-going object to the shared memory space and updates the header of the out-going object. In some embodiments, shared memory allocation program 300 processes the out-going object within a single block of shared memory and buffer space. In these embodiments, shared memory allocation program 300 associates a single memory address and memory pointer with the out-going object. In other embodiments, shared memory allocation program 300 processes the out-going object in segments that dictate utilizing multiple memory addresses, multiple memory pointers, and multiple sending buffers. In one example, shared memory allocation program 300 may use a FIFO (first in, first out) queue for the buffers containing the segments of the out-going object. In another example, shared memory allocation program 300 may process the segments comprising the out-going object as a doubly-linked list. Shared memory allocation program 300 communicates the multiple memory addresses, multiple memory pointers, and multiple sending buffers to fast path communication program 200 (FIG. 2, step 210).

In addition, shared memory allocation program 300 interacts with fast path memory management program 400 to update the header of the out-going object. In some embodiments, updating the header of the out-going object permits fast path direct memory access module 150 to control the behavior of GC 130 while transferring the object between computing entities.

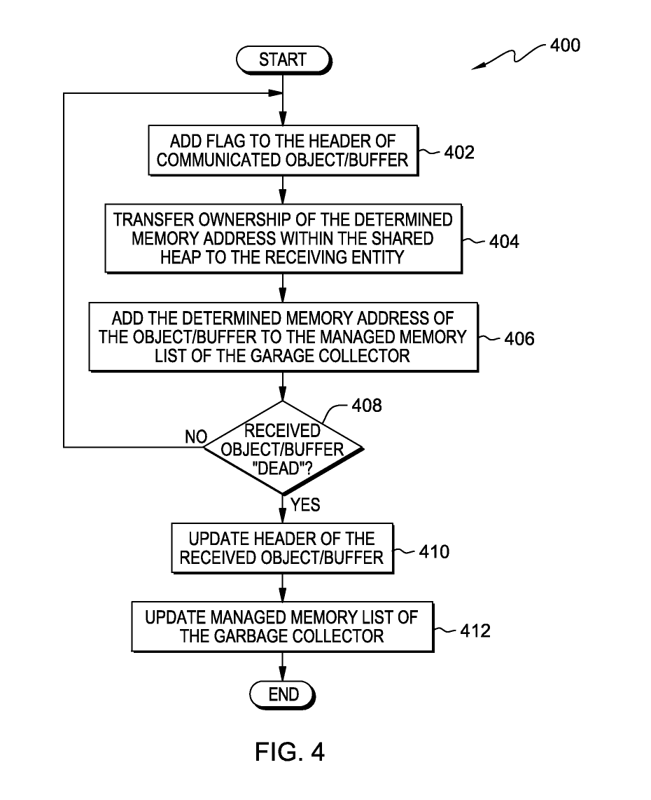

FIG. 4 is a flowchart depicting operational steps for fast path memory management program 400, executing on computing node 102 within virtualized computing environment 100 of FIG. 1. Fast path memory management program 400 adds a flag to the header of each object or buffer associated with the object of the communication. In addition to the flag in the header of each object or buffer comprising the object, fast path memory management program 400 updates the managed memory list of GC 130 to prevent the reclamation of allocated memory by GC 130. Fast path memory management program 400 monitors each object or buffer comprising the object of the communication to determine when each object or buffer is “dead.” The memory associated with a “dead” object/buffer is subsequently reclaimed by GC 130.

In step 402, fast path memory management program 400 adds a flag to the header of a communicated object/buffer. In one embodiment, fast path memory management program 400 adds a flag to the header of a communicated object. In another embodiment, fast path memory management program 400 adds a flag to the header of a segment of data comprising the communicated object. Fast path memory management program 400 subsequently uses the flag in the header of an object/buffer to control the behavior of GC 130.

In step 404, fast path memory management program 400 transfers ownership of the determined memory address within the shared heap to the receiving entity. In an embodiment, fast path memory management program 400 transfers ownership of the determined memory address within the shared heap from the transmitting entity (e.g., the sending entity, the first computing entity) to the receiving entity (e.g., the second computing entity). For example, fast path memory management program 400 may transfer the ownership of a memory address by replacing the PID of the sending entity with the PID of the receiving entity in a table controlled by a memory management program. In another example, fast path memory management program 400 may transfer the ownership of a memory address by replacing the MAC address of the sending entity with the MAC address of the receiving entity in a table controlled by a memory management program. In some instances, the memory management program is included in the OS or VM. In other instances, the memory management program is included in hypervisor 118.

In some embodiments, fast path memory management program 400 communicates with fast path communication program 200 to apply a lock to the sending buffer while transferring the ownership of the determined memory from the transmitting entity (e.g., the first computing entity) to the receiving entity (e.g., the second computing entity). In other embodiments, fast path memory management program 400 acquires a lock on a portion of allocated memory associated with a buffer prior to the buffer being added (e.g., enqueued) to a list. Locks may ensure the integrity of the links between nodes in a linked-list.

In step 406, fast path memory management program 400 adds the determined memory address of the object/buffer to the managed memory list of the garbage collector. In one embodiment, fast path memory management program 400 adds the determined memory address of the object/buffer to the managed memory list of GC 130. In another embodiment, GC 130 detects the flag added to the header of a communicated object/bugger by fast path memory management program 400. Subsequently, GC 130 adds the determined memory address of the flagged object/buffer to the managed memory list of GC 130. In some embodiments, fast path memory management program 400 receives an indication from, shared memory allocation program 300 that the allocated memory within the shared heap space is consumed. Fast path memory management program 400 communicates with fast path communication program 200 and pauses the redirection of the received object buffer (FIG. 2, step 218) until GC 130 reclaims shared heap memory, or shared memory allocation program 300 communicates that additional unused memory is available.

In decision step 408, fast path memory management program 400 determines whether a received object/buffer is “dead” (e.g., no longer needed, consumed). In some embodiments, fast path memory management program 400 determines that an object/buffer is “dead” when: the object/buffer is not utilized by the executing application of the receiving entity, the object/buffer is not referenced by the executing application of the receiving entity, and the object/buffer is “finalized” by a method function within the executing application of the receiving entity. In other embodiments, fast path memory management program 400 determines that an object/buffer may be “dead” when: the receiving ceases to execute, one or more endpoints of the communicating entities is removed from the global socket registry for the fast path communication solution, and the logical partition hosting the receiving entity is deprovisioned by hypervisor 118.

In decision step 408, in response to a determination that a received object/buff is “dead” (yes branch, decision step 408), then fast path memory management program 400 updates the header of the received object/buffer (step 410).

In step 410, fast path memory management program 400 updates the header of the received object/buffer. In an embodiment, fast path memory management program 400 removes the added flag from a received object/buffer that is determined to be “dead.” In another embodiment, fast path memory management program 400 updates the header of the received object/buffer after the transmission of the out-going object (e.g., information) is successful and the out-going object (e.g., information) is consumed by the receiving entity. In some embodiments, fast path memory management program 400 dequeues one or more buffers associated with the “dead” object.

In step 412, fast path memory management program 400 updates the managed memory list of GC 130. In some embodiments, fast path memory management program 400 communicates with GC 130 to reclaim the memory allocated to dead objects/buffers. In other embodiments, fast path memory management program 400 permits GC 130 to execute on a time-slice dictated by hypervisor 118 or another memory management function (not shown).

Referring to decision step 408, in response to a determination that a received object/buffer is not dead (no branch, decision step 408), fast path memory management program 400 does not update the object/buffer status. In one embodiment, fast path memory management program 400 pauses until the received object/buffer is determined to be “dead” (e.g., utilized, unneeded, finalized). In another embodiment, fast path memory management program 400 loops to acquire one or more additional objects/buffers. For example, a receiving entity cannot consume (e.g., utilize) a communicated object until the entire object is available. The object is distributed across multiple buffers so fast path memory management program 400 loops to step 402 until the buffers comprising the object are available. In some embodiments, multiple objects are utilized by the receiving entity and some or all of the objects are utilized before one or more of the received objects may be reclassified as “dead.”

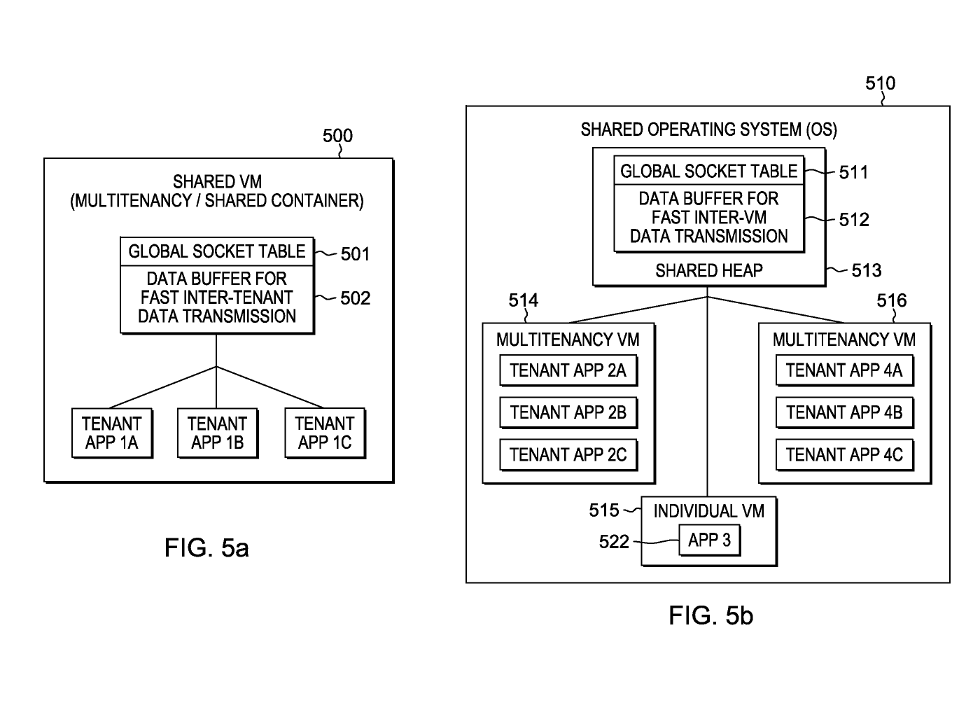

FIG. 5a is an illustrative example of a multitenancy (e.g., shared container, shared runtime system) fast path communication architecture within a shared virtual machine (VM), executing on computing node 102 within virtualized computing environment 100, in accordance with an embodiment of the present invention.

Shared VM 500 is an illustrative example of VM 136 within logical partition 108 of computing node 102. Shared VM 500 contains tenant app 1A, tenant app 1B, and tenant app 1C. In some embodiments, tenant app 1A, tenant app 1B, and tenant app 1C execute within a shared runtime. In other embodiments, tenant app 1A, tenant app 1B, and tenant app 1C execute within a shared container.

Global socket table 501 depicts a table utilized by shared VM 500. In one embodiment, communication module 160 registers the communication between tenant app 1A, tenant app 1B, and tenant app 1C with a table within global socket table 501. In another embodiment, fast path direct memory access module 150 registers the communication between tenant app 1A, tenant app 1B, and tenant app 1C with a table within global socket table 501. In an example, software on a server (e.g., an Internet service daemon, a super-server daemon, etc.) listens at networking ports for a TCP packet and then launches a server program based on the TCP packet content to generate the connection and register the endpoints of the connection. In an illustrative embodiment, tenant app 1A (e.g., transmitting entity) and tenant app 1C (e.g., receiving entity) transfer data (e.g., an object), and global socket table 501 receives updates to the TCP endpoints generated by tenant app 1A and tenant app 1C based on the network handshaking.

For example, global socket table 501 may be the look-up table for fastPathForSharedRunTimeSharedVM of communication module 160.

Data buffer for fast inter-tenant data transmission 502 is a portion of an illustrative embodiment utilizing the fast path direct memory access module 150 and communication module 160. Data buffer for fast inter-tenant data transmission 502 utilizes the memory of shared VM 500 to facilitate the transfer of data (e.g., an object) via direct memory access.

Tenant app 1A, tenant app 1B, and tenant app 1C are hosted software applications, such as shared databases, web sites, e-mail clients, social networking programs, support sites for mobile apps, etc.

FIG. 5b is an illustrative example multiple VMs utilizing fast path communication architecture within a shared OS, executing on computing node 102 within virtualized computing environment 100, in accordance with an embodiment of the present invention.

Shared operating system (OS) 510 is an illustrative example of multiple VMs executing within a shared OS in logical partition 104 of computing node 102. Multitenancy VM 514, individual VM 515, and multitenancy VM 516 may respectively depict VM 132, VM 133, and VM 134 of logical partition 104.

Global socket table 511 is an example of a table within communication module 160. In some embodiments, global socket table 511 is stored within fast path direct memory access module 150. Shared OS 510 registers the communications of: tenant app 2A, tenant app 2B, and tenant app 2C comprising multitenancy VM 514, app 3 of individual VM 515, and tenant app 4A, tenant app 4B, and tenant app 4C comprising multitenancy VM 516. For example, global socket table 511 may be the look-up table for fastPathForSharedOS of communication module 160. In an illustrative embodiment, tenant app 2A and app 3 transfer data (e.g., an object) and global socket table 511 receives the updated TCP endpoints generated by tenant app 2A and app 3 based on the network handshaking.

Data buffer for fast inter-VM data transmission 512 is a portion of an illustrative embodiment of the fast path direct memory access module 150 comprised of fast path communication program 200, shared memory allocation program 300, and fast path memory management program 400. Data buffer for fast inter-tenant data transmission 512 utilizes the shared heap memory to facilitate the transfer of data (e.g., an object) via direct memory access.

In some embodiments, shared heap 513 is a portion of memory 126 that hypervisor 118 provisioned for logical partition 104 that is not currently utilized by multitenancy VM 514, individual VM 515, and multitenancy VM 516. In other embodiments, shared heap 513 is a portion of virtualized memory allocated from memory 126 that hypervisor 118 provisioned for logical partition 104 that is not currently utilized by tenant app 2A, tenant app 2B, and tenant app 2C comprising multitenancy VM 514, app 3 of individual VM 515, and tenant app 4A, tenant app 4B, and tenant app 4C comprising multitenancy VM item 516.

Multitenancy VM 514 may be an illustrative example of an e-commerce website comprised of (e.g., hosting) multiple small businesses (e.g., tenant app 2A, tenant app 2B, tenant app 2C). Individual VM 515 is a virtual machine hosting app 3. Tenant app 2A, tenant app 2B, tenant app 2C, app 3, and tenant app 4A, tenant app 4B, and tenant app 4C are hosted software applications, such as shared databases, web sites, e-mail clients, social networking programs, etc.

In a further embodiment, the illustrative examples of Figure. 5a and Figure. 5b may be combined to utilize global socket look-up table fastPathForSharedHypervisor to implement yet another embodiment of the present invention. In such an embodiment, tenant app 1A of shared VM 500 and app 3 of individual VM 515 may transfer data via a fast path communication solution. For example, tenant app 1A may be a local weather station that transmits data to a regional weather data collection server (e.g., app 3 executing within individual VM 515).

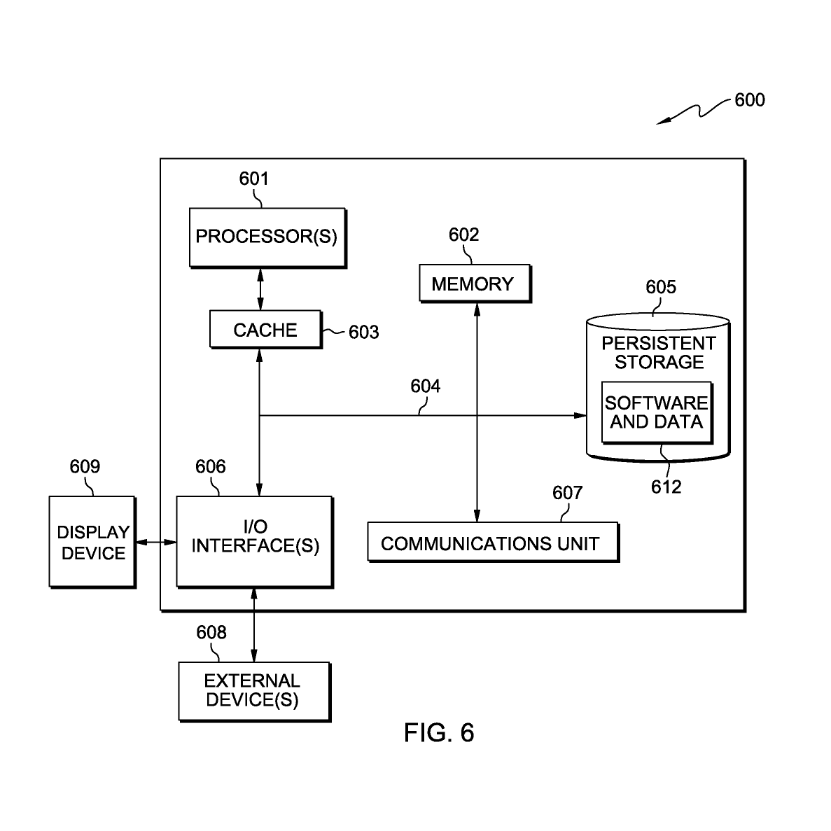

FIG. 6 depicts computer system 600, which is representative of computing node 102 and processors 120. Computer system 600 is an example of a system that includes software and data 612. Computer system 600 includes processor(s) 601, cache 603, memory 602, persistent storage 605, communications unit 607, input/output (I/O) interface(s) 606, and communication fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processor(s) 601 by holding recently accessed data, and data near recently accessed data, from memory 602. Memory 602 includes, at least in part, designated memory 126 (e.g., physical hardware) depicted in FIG. 1 to be shared among logical partitions.

Program instructions and data used to practice embodiments of the present invention may be stored in persistent storage 605 and in memory 602 for execution by one or more of the respective processor(s) 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, read-only memory (ROM), erasable programmable read-only memory (EPROM), flash memory, or any other computer readable storage media that is capable of storing program instructions or digital information. Persistent storage 605 includes, at least in part, disks 122 (e.g., physical hardware) depicted in FIG. 1 to be shared among logical partitions.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605. Software and data 612 are stored in persistent storage 605 for access and/or execution by one or more of the respective processor(s) 601 via cache 603 and one or more memories of memory 602. With respect to computing node 102, software and data 612 includes fast path direct memory access module 150 that includes fast path communication program 200, shared memory allocation program 300, and fast path memory management program 400. Fast path direct memory access module 150 may include shareable memory functions (not shown) and communication functions (not shown). With respect to computing node 102, software and data 612 also includes garbage collector (GC) 130, communication module 160 that includes memory management function (not shown), one or more look-up tables, and one or more global socket registry tables.

Communications unit 607, in these examples, provides for communications with other data processing systems or devices, including resources of computing node 102 and processors 120. In these examples, communications unit 607 includes one or more network interface cards. Communications unit 607 may provide communications through the use of either or both physical and wireless communications links. Hypervisor 118, virtual switch 128, software and data 612, garbage collector (GC) 130, communication module 160, and program instructions and data, used to practice embodiments of the present invention may be downloaded to persistent storage 605 through communications unit 607. Communication unit 607 includes, at least in part, one or more network cards 124 (e.g., physical hardware), shared Ethernet adapter (SEA) 112, and virtual adapters 114 and 116 depicted in FIG. 1 to be shared among logical partitions. I/O interface(s) 606 allows for input and output of data with other devices that may be connected to each computer system. For example, I/O interface 606 may provide a connection to external devices 608, such as a keyboard, keypad, a touch screen, and/or some other suitable input device. External devices 608 can also include portable computer readable storage media such as, for example, thumb drives, portable optical or magnetic disks, and memory cards. Software and data used to practice embodiments of the present invention can be stored on such portable computer readable storage media and can be loaded onto persistent storage 605 via I/O interface(s) 606. I/O interface(s) 606 also connect to display device 609.

Display device 609 provides a mechanism to display data to a user and may be, for example, a computer monitor. Display device 609 can also function as a touch screen, such as the display of a tablet computer or a smartphone.

It is understood in advance that although this disclosure discusses system virtualization, implementation of the teachings recited herein are not limited to a virtualized computing environment. Rather, the embodiments of the present invention are capable of being implemented in conjunction with any type of clustered computing environment now known (e.g., cloud computing) or later developed.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for transferring data utilizing direct memory access, the method comprising:
identifying, by one or more computer processors, a first computing entity and a second computing entity that are transferring data;
establishing, by one or more computer processors, one or more transmission control protocol (TCP) networking connections between the first computing entity and the second computing entity;
determining, by one or more computer processors, a shared memory space for the first computing entity and the second computing entity to utilize for transferring the data, wherein the shared memory space includes unused memory space;
allocating, by one or more computer processors, memory space of the determined shared memory space to the first computing entity and the second computing entity;
communicating, by one or more computer processors, a memory address that corresponds to the allocated memory space to the first computing entity and the second computing entity; and
transferring, by one or more computer processors, the data between the first computing entity and the second computing entity utilizing direct memory access and the allocated memory space.

2. The method of claim 1, further comprising:
updating, by one or more computer processors, one or more global socket registry tables based on information associated with the one or more established transmission control protocol network connections respectively associated with the first computing entity and the second computing entity, wherein the first computing entity and the second computing entity execute within a virtualized computing environment.

3. The method of claim 2, further comprising:
determining, by one or more computer processors, whether the first computing entity and the second computing entity are executing on a first virtual machine, based, at least in part on information associated with the one or more established transmission control protocol network connections respectively associated with the first computing entity and the second computing entity stored within the one or more global socket registry tables, and wherein the first virtual machine utilizes a first operating system; and
in response to determining that the first computing entity and the second computing entity are executing on a first virtual machine, enabling, by one or more computer processors, the transfer of data utilizing direct memory access between the first computing entity and the second computing entity.

4. The method of claim 2, further comprising:
determining, by one or more computer processors, whether the first computing entity and a third computing entity are respectively executing on a first virtual machine and a second virtual machine, based, at least in part on information associated with the one or more established transmission control protocol network connections respectively associated with the first computing entity and the third computing entity stored within the one or more global socket registry tables, and wherein the first virtual machine and the second virtual machine utilize a first operating system; and
in response to determining that the first computing entity and the third computing entity are respectively executing on the first virtual machine and the second virtual machine, enabling, by one or more computer processors, the transfer of data utilizing direct memory access between the first computing entity and the third computing entity.

5. The method of claim 2, further comprising:
determining, by one or more computer processors, whether the first computing entity and a fourth computing entity are respectively executing on a first virtual machine and a third virtual machine, based, at least in part on information associated with the one or more established transmission control protocol network connections respectively associated with the first computing entity and the fourth computing entity stored within the one or more global socket registry tables, and wherein the first virtual machine and the third virtual machine respectively utilize a first operating system and a second operating system, and wherein the first virtual machine and the third virtual machine execute within a first hypervisor; and
in response to determining that the first computing entity and the fourth computing entity are respectively executing on the first virtual machine and the third virtual machine, enabling, by one or more computer processors, the transfer of data utilizing direct memory access between the first computing entity and the fourth computing entity.

6. The method of claim 1, wherein transferring the data further comprises:
modifying, by one or more computer processors, a header of the data, prior to transferring the data, to include an indication for a memory management function perform an action including, at least one of: not moving the data to another memory location, not reclaiming the allocated portion of unused memory space, and updating a managed memory list of the memory management function identifying the allocated portion of unused memory space.

7. The method of claim 6, wherein transferring the data further comprises:
determining, by one or more computer processors, that the transfer of data between first computing entity and the second computing entity is successful and that the information is used by one of the first computing entity and the second computing entity; and
in response to determining that the information between first computing entity and the second computing entity is successful and that the information is used by one of the first computing entity and the second computing entity, updating, by one or more computer processors, the managed memory list of the memory management function such that the memory management function reclaims the allocated portion of unused memory space.

8. A computer program product for transferring data utilizing direct memory access, the computer program product comprising:
one or more computer readable storage media and program instructions stored on the one or more computer readable storage media, the program instructions comprising:
program instructions to identify a first computing entity and a second computing entity that are transferring data;
program instructions to establish one or more transmission control protocol (TCP) networking connections between the first computing entity and the second computing entity;
program instructions to determine a shared memory space for the first computing entity and the second computing entity to utilize for transferring the data, wherein the shared memory space includes unused memory space;
program instructions to allocate memory space of the determined shared memory space to the first computing entity and the second computing entity;
program instructions to communicate a memory address that corresponds to the allocated memory space to the first computing entity and the second computing entity; and
program instructions to transfer the data between the first computing entity and the second computing entity utilizing direct memory access and the allocated memory space.

9. The computer program product of claim 8, further comprising:
program instructions to update one or more global socket registry tables based on information associated with the one or more established transmission control protocol network connections respectively associated with the first computing entity and the second computing entity, wherein the first computing entity and the second computing entity execute within a virtualized computing environment.

10. The computer program product of claim 9, further comprising:
program instructions to determine whether the first computing entity and the second computing entity are executing on a first virtual machine, based, at least in part on information associated with the one or more established transmission control protocol network connections respectively associated with the first computing entity and the second computing entity stored within the one or more global socket registry tables, and wherein the first virtual machine utilizes a first operating system; and
in response to determining that the first computing entity and the second computing entity are executing on a first virtual machine, program instructions to enable the transfer of data utilizing direct memory access between the first computing entity and the second computing entity.

11. The computer program product of claim 9, further comprising:
program instructions to determine whether the first computing entity and a third computing entity are respectively executing on a first virtual machine and a second virtual machine, based, at least in part on information associated with the one or more established transmission control protocol network connections respectively associated with the first computing entity and the third computing entity stored within the one or more global socket registry tables, and wherein the first virtual machine and the second virtual machine utilize a first operating system; and
in response to determining that the first computing entity and the third computing entity are respectively executing on the first virtual machine and the second virtual machine, program instructions to enable the transfer of data utilizing direct memory access between the first computing entity and the third computing entity.

12. The computer program product of claim 9, further comprising:
program instructions to determine whether the first computing entity and a fourth computing entity are respectively executing on a first virtual machine and a third virtual machine, based, at least in part on information associated with the one or more established transmission control protocol network connections respectively associated with the first computing entity and the fourth computing entity stored within the one or more global socket registry tables, and wherein the first virtual machine and the third virtual machine respectively utilize a first operating system and a second operating system, and wherein the first virtual machine and the third virtual machine execute within a first hypervisor; and
in response to determining that the first computing entity and the fourth computing entity are respectively executing on the first virtual machine and the third virtual machine, program instructions to enable the transfer of data utilizing direct memory access between the first computing entity and the fourth computing entity.

13. The computer program product of claim 8, further comprising:
program instructions to modify a header of the data, prior to transferring the data, to include an indication for a memory management function perform an action including, at least one of: not moving the data to another memory location, not reclaiming the allocated portion of unused memory space, and updating a managed memory list of the memory management function identifying the allocated portion of unused memory space.

14. The computer program product of claim 13, further comprising:
program instructions to determine that the transfer of data between first computing entity and the second computing entity is successful and that the information is used by one of the first computing entity and the second computing entity; and
in response to determining that the information between first computing entity and the second computing entity is successful and that the information is used by one of the first computing entity and the second computing entity, program instructions to update the managed memory list of the memory management function such that the memory management function reclaims the allocated portion of unused memory space.

15. A computer system for transferring data utilizing direct memory access, the computer system comprising:
one or more computer processors;
one or more computer readable storage media;
program instructions to identify a first computing entity and a second computing entity that are transferring data;
program instructions to establish one or more transmission control protocol (TCP) networking connections between the first computing entity and the second computing entity;
program instructions to determine a shared memory space for the first computing entity and the second computing entity to utilize for transferring the data, wherein the shared memory space includes unused memory space;
program instructions to allocate memory space of the determined shared memory space to the first computing entity and the second computing entity;
program instructions to communicate a memory address that corresponds to the allocated memory space to the first computing entity and the second computing entity; and
program instructions to transfer the data between the first computing entity and the second computing entity utilizing direct memory access and the allocated memory space.

16. The computer system of claim 15, further comprising:
program instructions to update one or more global socket registry tables based on information associated with the one or more established transmission control protocol network connections respectively associated with the first computing entity and the second computing entity, wherein the first computing entity and the second computing entity execute within a virtualized computing environment.

17. The computer system of claim 16, further comprising:
program instructions to determine whether the first computing entity and the second computing entity are executing on a first virtual machine, based, at least in part on information associated with the one or more established transmission control protocol network connections respectively associated with the first computing entity and the second computing entity stored within the one or more global socket registry tables, and wherein the first virtual machine utilizes a first operating system; and
in response to determining that the first computing entity and the second computing entity are executing on a first virtual machine, program instructions to enable the transfer of data utilizing direct memory access between the first computing entity and the second computing entity.

18. The computer system of claim 16, further comprising:
program instructions to determine whether the first computing entity and a third computing entity are respectively executing on a first virtual machine and a second virtual machine, based, at least in part on information associated with the one or more established transmission control protocol network connections respectively associated with the first computing entity and the third computing entity stored within the one or more global socket registry tables, and wherein the first virtual machine and the second virtual machine utilize a first operating system; and
in response to determining that the first computing entity and the third computing entity are respectively executing on the first virtual machine and the second virtual machine, program instructions to enable the transfer of data utilizing direct memory access between the first computing entity and the third computing entity.

19. The computer system of claim 16, further comprising:
program instructions to determine whether the first computing entity and a fourth computing entity are respectively executing on a first virtual machine and a third virtual machine, based, at least in part on information associated with the one or more established transmission control protocol network connections respectively associated with the first computing entity and the fourth computing entity stored within the one or more global socket registry tables, and wherein the first virtual machine and the third virtual machine respectively utilize a first operating system and a second operating system, and wherein the first virtual machine and the third virtual machine execute within a first hypervisor; and
in response to determining that the first computing entity and the fourth computing entity are respectively executing on the first virtual machine and the third virtual machine, program instructions to enable the transfer of data utilizing direct memory access between the first computing entity and the fourth computing entity.

20. The computer system of claim 15, further comprising:
program instructions to modify a header of the data, prior to transferring the data, to include an indication for a memory management function perform an action including, at least one of: not moving the data to another memory location, not reclaiming the allocated portion of unused memory space, and updating a managed memory list of the memory management function identifying the allocated portion of unused memory space.
